(19) United States
(12) Patent Application Publication
(10) Pub. No.: US 2016/0034476 A1
(43) Pub. Date: Feb. 4, 2016

(54) FILE MANAGEMENT METHOD

(71) Applicant: HITACHI, LTD., Tokyo (JP)

(72) Inventors: Kazumasa MATSUBARA, Tokyo (JP); Mitsuo HAYASAKA, Tokyo (JP); Hitoshi KAMEI, Tokyo (JP)

(73) Assignee: Hitachi, Ltd., Tokyo (JP)

(21) Appl. No.: 14/423,762

(22) PCT Filed: Oct. 18, 2013
(86) PCT No.: PCT/JP2013/078374

§ 371 Date: Feb. 25, 2015

(51) Int. Cl. G06F 17/30

(52) U.S. Cl. CPC G06F 17/30082; G06F 17/30091

(57) ABSTRACT

A file management method according to the present invention is based upon a file management method of making a file from a client to a storage device redundant by a certain redundant number and storing the file in the storage device, and the file management method according to the present invention includes a first step of accepting an additional file from the client to the storage device, a second step of comparing capacity of the additional file and unused physical capacity of the storage device and a third step of changing the redundant number of the already stored file, increasing the unused physical capacity and storing the additional file in the storage device when the capacity of the additional file is larger than the unused physical capacity.

### TECHNICAL FIELD

The present invention relates to a file management method.

### BACKGROUND ART

Recently, technology called big data analysis that produces a new value by analyzing enormous data related to social infrastructure such as social networking service, banking, medical treatment and traffic is being put into practice.

In big data analysis each volume of input data collected from social infrastructure and output data which is results of analysis is very big and continues to increase over time.

For example, when big data is analyzed utilizing cloud service, the problem is remarkable. As for computing resources of cloud service, cloud service is often counted based upon the performance of a computer and usage time and as to storage resources, cloud service is often counted based upon data capacity and a recording period. Therefore, when data capacity increases, a usage charge related to storage resources is more dominant than a usage charge related to computing resources as a total cost. Therefore, when big data analysis is made utilizing cloud service, a cost of utilizing cloud service is enormous.

For a method of enhancing the usage efficiency of storage resources, technique for providing (selling) and utilizing (buying) resources allocated to a user among users smoothly as disclosed in Patent Literature 1 can be given. Unused resources of users are sold and bought by using this technique and the usage efficiency of the unused resources can be enhanced.

Besides, as a cost for collecting input data is also expensive, the reliability of storage resources is also important.

### CITATION LIST

### Patent Literature

Patent Literature 1: Japanese Patent Application Laid-Open No. 2011-154532

### SUMMARY OF INVENTION

### Technical Problem

Technique disclosed in Patent Literature 1 enables providing and utilizing resources possessed by users among the users. At this time, a user that receives some resource acquires the ownership of the provided resource. Therefore, since another user has the ownership of the resource even if the user that provided the resource desires the recovery of the resource, there is a problem that the resource cannot be recovered.

Then, an object of the present invention is to enable recovering an accommodated resource, enabling accommodating an unused area.

### Solution to Problem

A file management method according to the present invention is based upon a file management method of storing a file from a client in a storage in a state where the file is made redundant by a certain redundant number and has a characteristic that the file management method includes a first step of accepting an additional file from the client to the storage, a second step of comparing the capacity of the additional file and the unused physical capacity of the storage and a third step of changing the redundant number of the already stored file, increasing the unused physical capacity and storing the additional file in the storage device when the capacity of the additional file is larger than the unused physical capacity.

Besides, the file management method according to the present invention is based upon a file management method of allocating physical allocation capacity of a storage to plural users, enabling lending and borrowing/allocated physical allocation capacity and storing a file from a client of the user in the storage device where the file is made redundant by a certain redundant number, and has a characteristic that the file management method includes a step of accepting an additional file from the client to the storage device, a step of adding capacity of the additional file and the capacity of all the already stored files of the first user who possesses the additional file and comparing the added capacity with capacity acquired by subtracting lent capacity from the physical allocation capacity allocated to the first user, and a step of changing a redundant number of an already stored file of a user at the destination of lending and storing the additional file in capacity made free by changing the redundant number when the added capacity is larger.

### Advantageous Effects of Invention

According to the present invention, the recovery of a provided area is enabled by changing a redundant number.

### BRIEF DESCRIPTION OF DRAWINGS

FIG. 1A shows an example of lending unused capacity between users.

FIG. 1B shows an example of recovering capacity between users and changing a redundant number.

FIG. 2 shows an example of system configuration.

FIG. 3 shows an example of a user management table.

FIG. 4 shows an example of a file management table.

FIG. 5 is an example of a flowchart showing a file writing process by a data manager.

FIG. 6 is an example of a flowchart showing a process by a redundant number adjuster.

FIG. 7 is an example of a flowchart showing process by a capacity recoverer.

FIG. 8 is an example of a flowchart showing a file deletion process by the data manager.

FIG. 9 shows an example of a redundant number reduction priority setting screen.

FIG. 10 shows an example of a screen for setting accommodation among users.

FIG. 11 is an example of a flowchart showing a file writing process by the capacity recoverer.

FIG. 12 shows an example of a screen for setting lent/borrowed capacity between users.

FIG. 13 shows an example of the configuration of a system using a cloud storage.

FIG. 14A shows an example of a cloud information table.

FIG. 14B shows an example of a store combination table.

FIG. 15 shows an example a user management table corresponding to a cloud.

FIG. 16 shows an example of a file management table corresponding to the cloud.

### DESCRIPTION OF EMBODIMENTS

Embodiments in which the capacity of a storage is accommodated among users will be described using a system that stores a file in a storage via a computer (a gateway) with the file made redundant so as to protect the file for an example below. For an outline of the accommodation, (1) unused capacity of capacity allocated to a user can be lent to another user who has the relation of accommodation. (2) To enable recovery even if the lent capacity is utilized by another user, the data redundancy of the borrowing user is reduced and recovered capacity can be secured. (3) The redundancy of the whole data is made minimum so that the whole data is stored in the capacity allocated to the user himself/herself so as to enable the securement of recovered capacity without deleting own data.

In a first embodiment, a system that stores a file in three physical volumes in a storage device in a state where the file is made redundant will be described using an example. The example that unused capacity is automatically distributed in a group in the relation of accommodation in a state where files having the same contents are stored by a redundant number will be described below. In a second embodiment, an example that unused capacity is lent and recovered to/from an individual user in place of the distribution in the group in the first embodiment will be described. In a third embodiment, a system that stores a file in three cloud storages will be described using an example. In the first embodiment, the redundant number of the file is used for an index, while in the third embodiment, availability information provided by Service Level Agreement (hereinafter called SLA) as redundancy shall be used for an index.

### First Embodiment

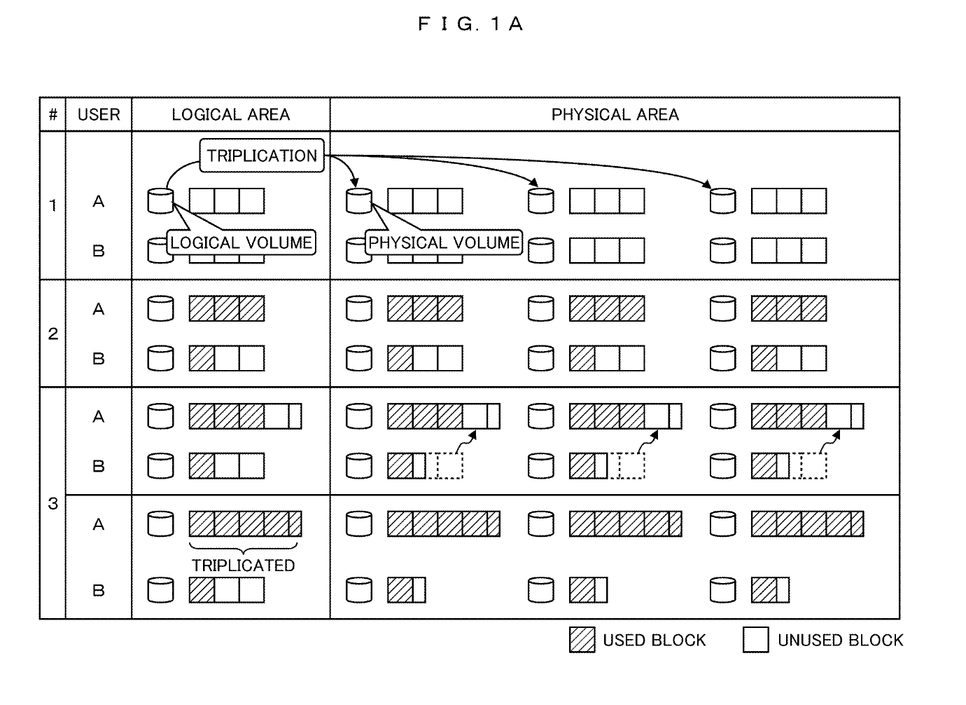

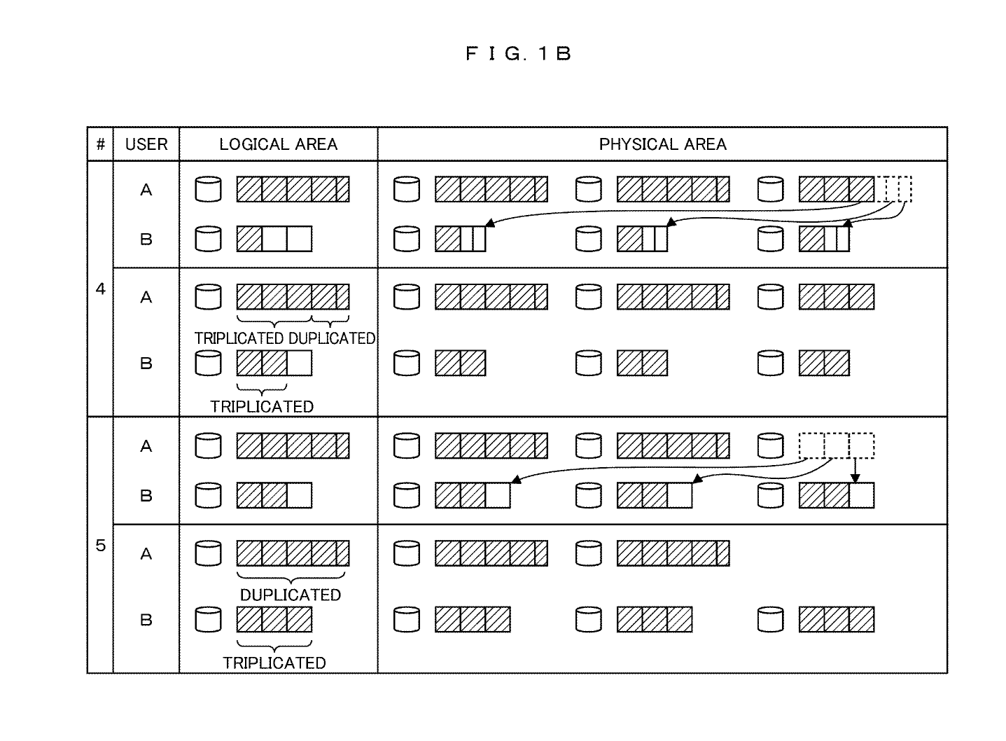

Referring to FIGS. 1 to 10, the first embodiment will be described below. In the first embodiment, operation in a case where a file is stored in excess of capacity allocated to a user (hereinafter called logical allocation capacity) when a manager allocates the capacity of a storage device to each user will be described. An actual storage area (a physical allocation area) allocated to each user is secured by times of a redundant number of a logical allocation area for redundant storage.

This embodiment also includes (1) processing for storing a file by reducing redundancy as a group and securing an unused physical allocation area in the case of the excess of an initial logical allocation area and (2) processing for complementing redundancy by borrowing an unused physical allocation area from another user when the redundancy is reduced.

FIGS. 1A and 1B show the reduction of redundancy in a use in excess of capacity allocated to a user and operation for borrowing capacity from another user and complementing redundancy. This system guarantees that storage is capable within the capacity of initial physical volumes (equivalent to nine blocks in the drawings) allocated to each user though redundancy is reduced. Nos. 1 to 8 will be described in order. In No. 1, a manager provides each logical volume for three blocks to users A and B. Since one block of the logical volume is triplicated in initial setting, it grows into three blocks of the physical volume. Each user changes redundancy in the physical volumes for total nine blocks, provides an unused area and recovers the area. In No. 2, a case where data is stored in capacity allocated to each user is shown. In No. 3, a case where the user A borrows capacity from the user B in excess of an area initially allocated and stores there is shown. A user A borrows capacity for 1.5 blocks from the user B to store data for 4.5 blocks of the physical volume and uses it as own block.

In No. 4, a case where the user B stores data for two blocks of the physical volume is shown. The user B has only 4.5 blocks of the physical volumes because the user B lends the user A 4.5 blocks, and therefore the user B recovers 1.5 blocks of the physical volumes from the user A. At this time, since the user A returns 1.5 blocks of the physical volumes, duplication is applied to a part of the blocks in place of triplication. In No. 5, the user B similarly recovers 3 blocks from the user A to store data for three blocks of physical volumes. Since the user B stores data in capacity initially allocated, the data is all triplicated. In the meantime, as the user A stores in excess of capacity initially allocated and has no area to borrow, the data is stored with it duplicated. As described above, in this embodiment, a function for lending and recovering capacity between users is provided.

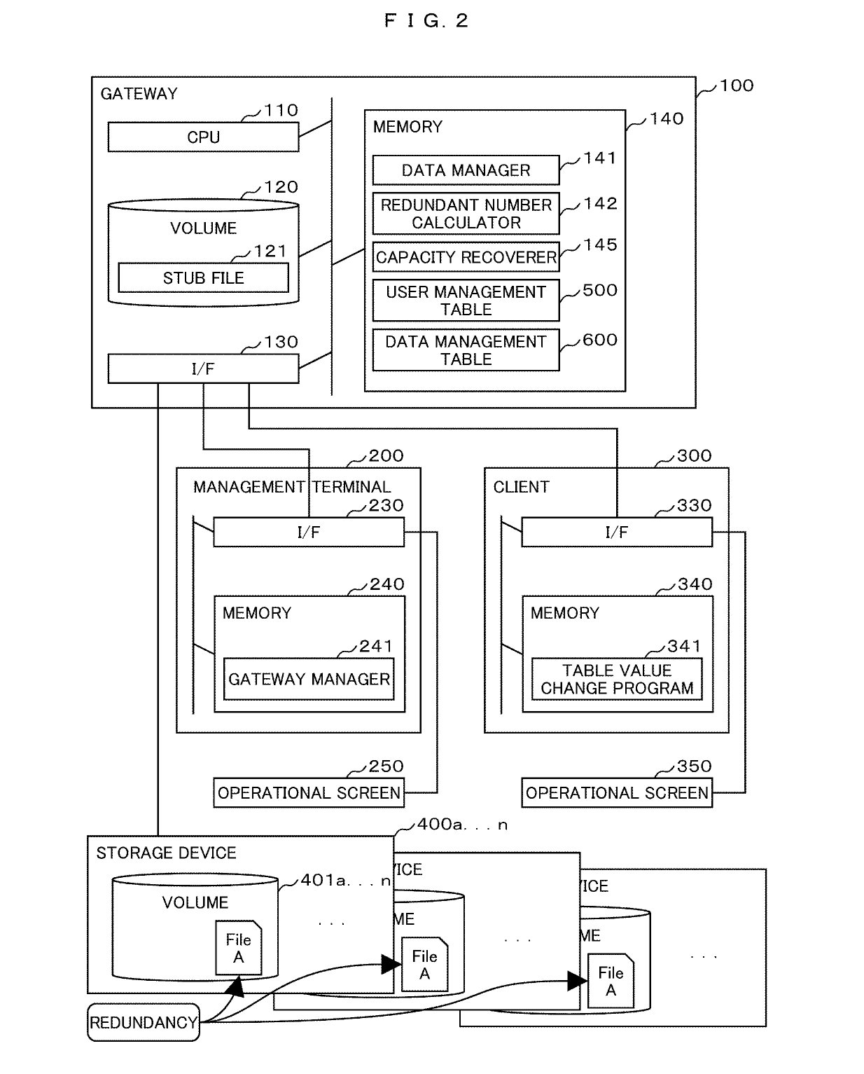

FIG. 2 shows an example of the configuration of a file storage system that stores a file in a volume of a storage device with the file redundant.

A gateway 100 is a computer that provides file storage service to a client 300. Therefore, the gateway 100 transfers a file between the client 300 and the storage device 400. A CPU 110 executes a processor (a program) stored in a memory 140. The memory 140 stores processors (programs) and tables for the file storage service. In the memory 140, a data manager 141, a redundant number calculator 142 and a capacity recoverer 145 are stored. In the memory, a user management table 500 and a file management table 600 are also stored. Further, the memory 140 has an area such as a work area required for executing each processor. A volume 120 stores a stub file 121. The stub file 121 holds a file ID for every user. An interface (I/F) 130 transmits/receives a file to/from the client 300 and the storage device 400. Besides, the interface transmits/receives management information to/from a management terminal 200 and the client 300. However, each processor may not be a program executed in the CPU 110 but may be independent hardware that performs the same operation as operation when the CPU 110 executes a program.

The management terminal 200 can acquire management information in the gateway 100 and the storage device 400 if necessary, is a terminal for managing the gateway 100, and is a computer provided with an interface (I/F) 230 for connecting to a network and an operational screen, a memory 240 and an internal communication line for connecting them. The memory 240 stores a processor (a program) and data. The processor is a gateway manager 241 for example. The operational screen 250 inputs and outputs the management information of the gateway 100 via the management terminal 200.

The client 300 is a computer used by a user who utilizes file storage service provided by the gateway 100 and is provided with an interface (I/F) 330 for connecting the network and the operational screen, a memory 340 and an internal communication line for connecting them. A operational screen 350 inputs and outputs the management information of the gateway 100 via the client 300.

The storage device 400 provides file storage service (writing, reading, updating, deletion and the like) corresponding to an instruction from the gateway 100. Therefore, the storage device 400 has single/plural volumes 401 for storing a file. Besides, a file ID for identifying a file is used for writing/reading the file. The gateway 100 allocates a proper file ID to each file.

A case where a file is written from the client 300 will be described below. The client 300 transmits a file to the gateway 100. The gateway 100 allocates a proper file ID to the received file and transmits it to the storage device 400. The gateway 100 holds the correlation of the file ID and path information showing a location in which the file is stored every user as stub information. When the client 300 reads the file, the client 300 has only to refer to the stub information by storing the file in the storage device as described above.

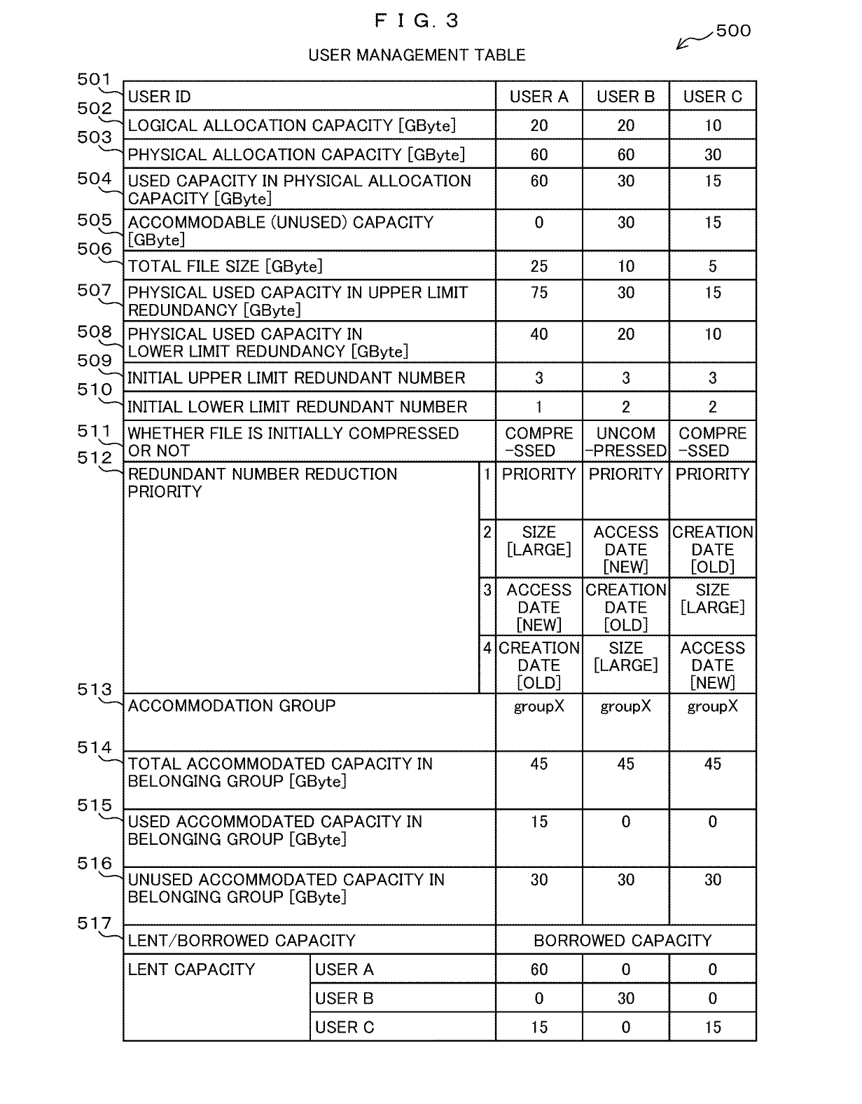

FIG. 3 shows an example of the user management table 500. The user management table 500 is a table for managing allocation information, the priority information of a file the redundancy of which is reduced and accommodation information. A user ID 501 is an identifier for managing files stored in the storage device 400 every user ID. Logical allocation capacity 502 shows logical capacity allocated by the manager. Physical allocation capacity 503 is capacity acquired by multiplying an initial redundant number supposed by the manager and logical allocation capacity. Physical used capacity 504 shows capacity utilized by a user in physical allocation capacity. Accommodable (unused) capacity 505 shows capacity acquired by subtracting physical used capacity from physical allocation capacity and when a user belongs to an accommodation group, the accommodable capacity is equivalent to maximum capacity which can be provided to another user.

Total file size 506 shows the total of files except redundant files. Physical used capacity in upper limit redundancy 507 shows used quantity of capacity when all files that a user possesses reach a set upper limit redundant number. When this capacity exceeds physical allocation capacity, capacity is accommodated from another user or the redundant number of some files is required to be reduced so as to keep in physical allocation capacity. A lower limit redundant number physical used capacity 508 shows used quantity of capacity when all files that a user possesses reach a set lower limit redundant number. These values function as a limit value for limiting physical used capacity of a user because all files that a user possesses are required to be held in physical allocation capacity when no capacity can be borrowed from another user. An initial upper limit redundant number 509 and an initial lower limit redundant number 510 show an initial upper limit redundant number and an initial lower limit redundant number respectively set to an added file.

Whether a file is initially compressed or not 511 shows whether a file is automatically compressed or not when the file is written. Redundant number reduction priority 512 shows priority information for determining the order of sorting when a redundant number is reduced. For example, as for the user A, the weight of sorting is determined in the order of priority information, size, an access date and a creation date. Size [large] shows that a redundant number is precedently reduced from larger size. An accommodation group 513 shows that accommodable (unused) capacity that a user possesses can be provided to a user who belongs to the same group. Total accommodated capacity in a belonging group 514 shows a value acquired by totaling accommodable (unused) capacity of all users who belong to the same group. Used accommodated capacity 515 in the belonging group 515 shows capacity which a user utilizing in excess of physical allocation capacity borrows from unused capacity of a user who belongs to the same group. Unused accommodated capacity 516 in the belonging group 516 shows capacity which is not used by another user in the total accommodated capacity in the belonging group 514. Lent/borrowed capacity 517 will be described later because it is described in a second embodiment and is not described in the first embodiment.

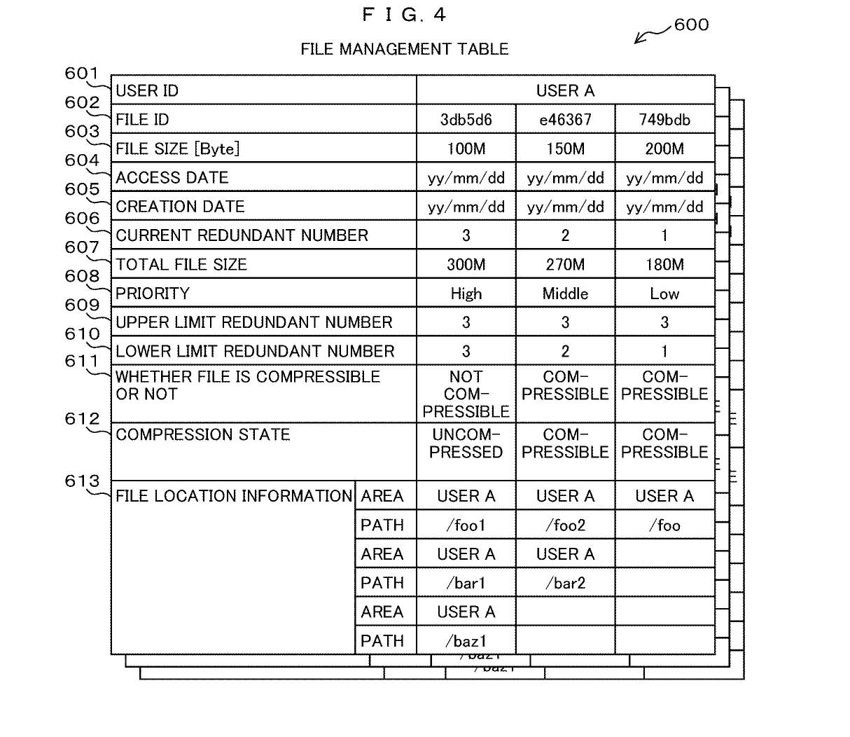

FIG. 4 shows an example of the file management table 600. A user ID 601 is an identifier for managing files stored in the storage device 400 every user ID. A file ID 602 is a file identifier for uniquely identifying files stored in the storage device 400. A file size 603 shows the size of a file itself in which no redundancy is considered. An access date 604 shows a date of last access. A creation date 605 shows a date of creation. A current redundant number 606 shows how the corresponding file is made redundant. A total file size 607 shows used quantity of physical capacity to which redundancy is added. Priority 608 is utilized as a first index when a redundant number is changed. In this case, for example, setting that a redundant number is reduced precedently from Low at three levels of Low, Middle and High is shown. An upper limit redundant number 609 shows a maximum redundant number in which a file can be made redundant. A lower limit redundant number 610 shows a redundant number to be maintained at the minimum when a redundant number is reduced. Whether file is compressible or not 611 shows whether a file is compressible or not. A compressed state 612 shows whether a file is in a compressed state or in an uncompressed state. File location information 613 shows a location written to the storage device 400.

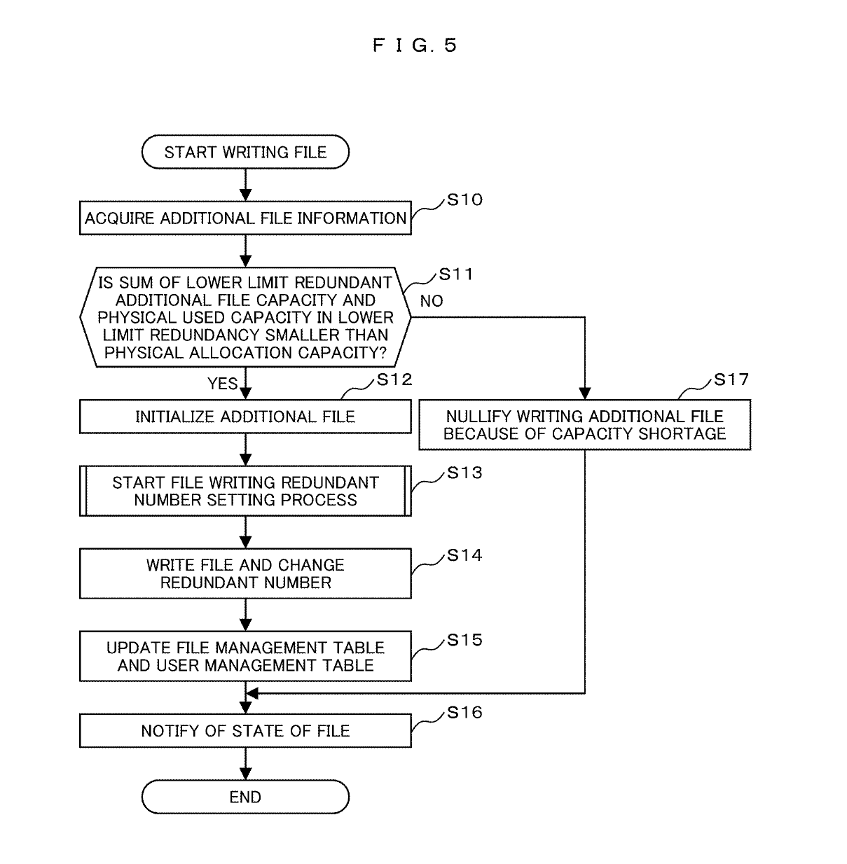

FIG. 5 is an example of a flowchart showing a file writing process by the data manager 141 of the gateway 100. In this example, a case where setting for the accommodation of unused capacity among users is made and a group for the accommodation is created is shown. In the group, accommodated capacity is automatically distributed to each user who cannot store at an upper limit redundant number based upon a rate of excess quantity when the group has accommodable capacity.

First, the data manager 141 (the execution of a program called the data manager 141 by the CPU 110) acquires a request for writing a file from the client 300 and the information of the file. In this case, the user ID shall be the user A and a file shall be an additional file (S10). The data manager 141 verifies whether the user A can store the additional file or not. When it is supposed that the existing file and the additional file are set to the lower limit redundant number, the data manager judges whether the current used capacity exceeds a value of the physical allocation capacity 503 of the user A. When the current used capacity does not exceed the value, processing proceeds to a step S12 and when the current used capacity exceeds the value, the processing proceeds to a step S17 (S11). Judgment of whether the current used capacity exceeds the value or not also includes judgment of whether the existing file and the additional file can be stored in terms of capacity including an error and the like in numeric representation in a computer in addition to judgment by mathematically strict comparison. Judgment in the following description is also similar.

The data manager 141 initializes a file referring to the user management table 500 (S12). Next, the data manager 141 sets a file redundant number of the user A and a user who belongs to the same group using the redundant number calculator 142 (S13). The data manager writes the file in the storage device based upon a changed redundant number of the file (S14) and updates the file management table and the user management table (S15). When the redundant number of the file is changed, the user is notified of it (S16). When the current used capacity exceeds the value of the physical allocation capacity 503 even if the existing file and the additional file are set to the lower limit redundant number, the capacity is short and writing fails (S17).

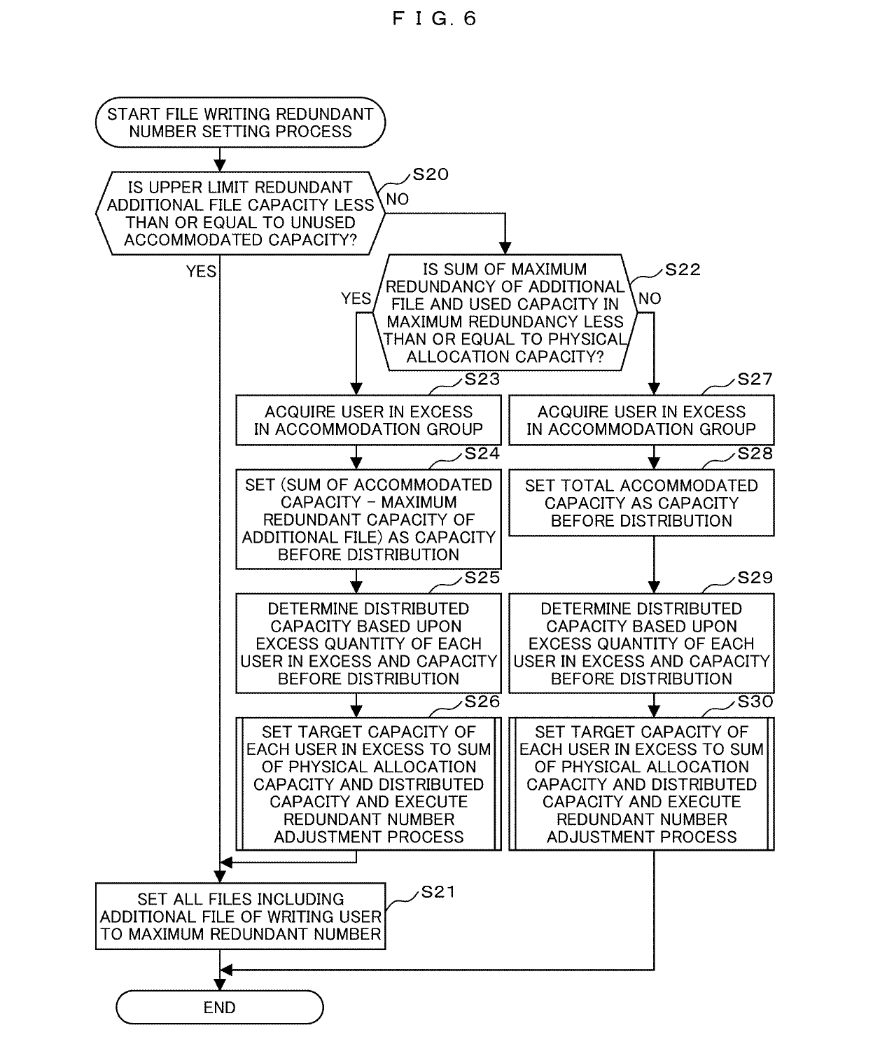

FIG. 6 is an example of a flowchart showing a process by the redundant number calculator 142 of the gateway 100 and shows the details of the redundant number determining step (S12) shown in FIG. 5. The capacity of the additional file supposed to be set to the upper limit redundant number and the capacity of the unused accommodated capacity in the belonging group (hereinafter called the unused accommodated capacity) 516 in the user management table 500 are compared. When the additional file is smaller than the capacity of the unused accommodated capacity 516, processing proceeds to a step S21. When the additional file is larger, the processing proceeds to a step S22 (S20). Since the additional file can be stored at the upper limit redundant number in capacity acquired by adding the value of the physical allocation capacity 503 that the user A has and a value of the unused accommodated capacity 516, the additional file is stored with the additional file set to the upper limit redundant number (S21). In S21, all files already stored may also be changed to the maximum redundant number and may also be unchanged.

When the additional file cannot be stored at a value of the upper limit redundant number, states are compared to recover capacity or to distribute accommodated capacity. In the case of recovering capacity, the processing proceeds to a step S23 and when accommodated capacity is distributed, the processing proceeds to a step S27 (S22). When it is determined that the processing proceeds to S23, a value of the physical used capacity in upper limit redundancy 507 and the value of the physical allocation capacity 503 are compared as to each user in the group and a user who exceeds the value of the physical allocation capacity 503 is acquired (S23). Capacity acquired by subtracting the capacity of the additional file set to upper limit redundancy from the total accommodated capacity is capacity before distribution (S24). Distributed capacity is determined based upon excess quantity of each user in excess of capacity and the capacity before distribution (S25). Capacity in which the file can be stored (target capacity) is specified for each user in excess of capacity and a redundant number adjustment process is executed. At this time, as the user A is not included in the redundant number adjustment process, the processing proceeds to S21 (S26).

When it is determined that the processing proceeds to S27 in S22, the similar processing to the processing in S23 is executed (S27) and total accommodated capacity is made the capacity before distribution (S28). Distributed capacity is determined based upon excess quantity of each user in excess of capacity and the capacity before distribution (S29). Capacity in which the file can be stored (target capacity) is specified for each user in excess of capacity and the redundant number adjustment process is executed. At this time, the user A is also included in the redundant number adjustment process (S30).

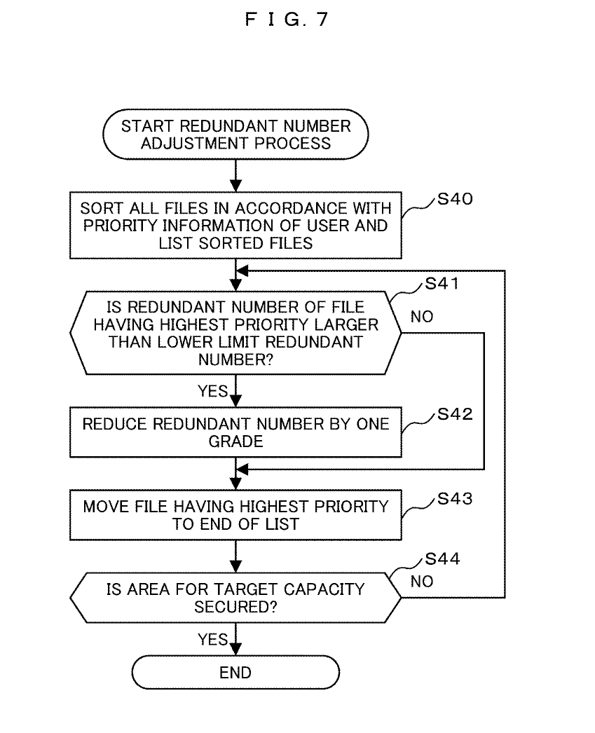

FIG. 7 is an example of a flowchart showing a process by the capacity recoverer 146 of the gateway 100. A redundant number is adjusted so that the capacity of an object user is in a range of target capacity and FIG. 7 shows the details of S26 and S30 in FIG. 6. The process is a process in which a redundant number of a file is reduced from the maximum redundant number in the order of higher priority in the list is repeatedly reduced until recovered quantity is secured. As for a user to whom the adjustment of a redundant number is applied, a value of the redundant number reduction priority 512 in the user management table 500 is acquired, all files that the user possesses are sorted, and a list is created (S40). It is judged whether the current redundant number of a file with the highest priority is a lower limit redundant number (S41). When the current redundant number is not the lower limit redundant number, the redundant number is reduced by one (S42). When the current redundant number is the lower limit redundant number, the processing proceeds to a step S43 without changing the redundant number. The file with the highest priority is shifted to an end of the list (the highest priority is turned the lowest priority) (S43). It is judged whether an area for a target area (recovered capacity) can be secured by reducing the redundant number (S44). When the area can be secured, the process is finished. When the area cannot be secured, the redundant number is reduced and the processing is returned to S41 to secure the area.

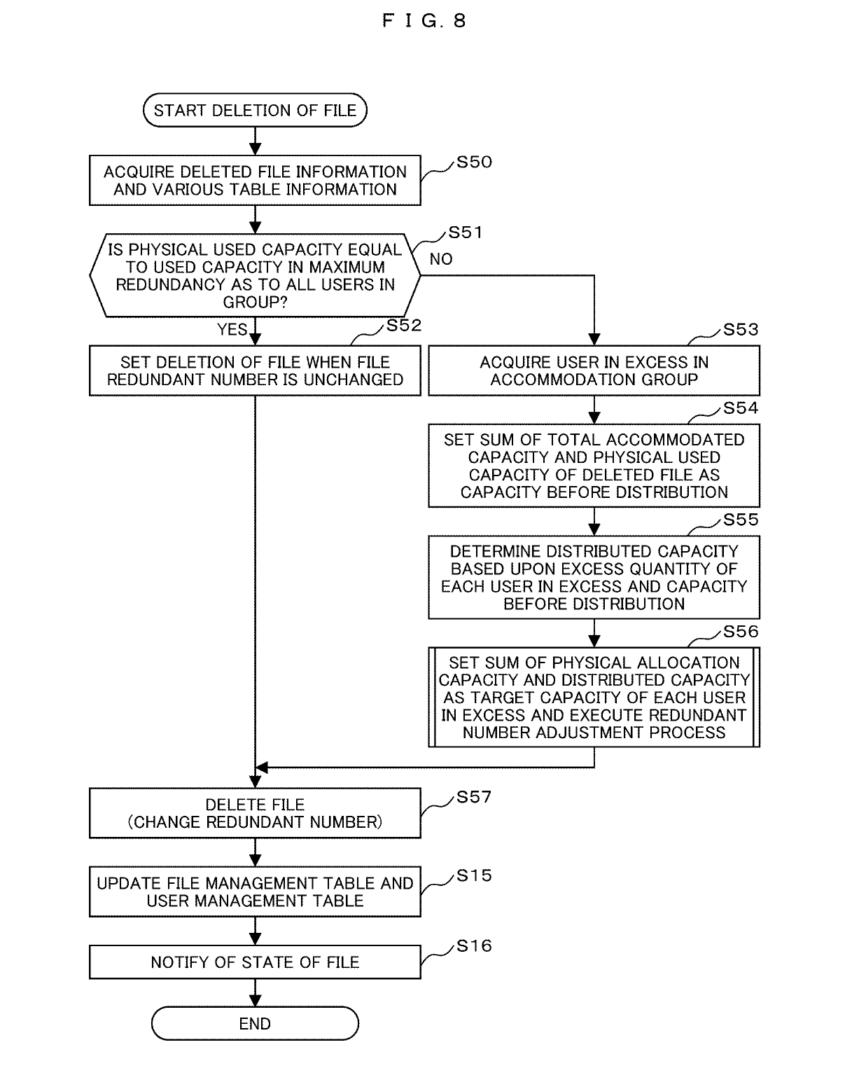

FIG. 8 is an example of a flowchart showing a file deletion process by the data manager 141 of the gateway 100. For example, the additional file described referring to FIGS. 5 to 7 can be deleted. As accommodated capacity may increase when a file is deleted, newly increased accommodated capacity is distributed. The description of the similar processing to that shown in FIG. 5 is omitted. In the case of the file writing process, it is judged whether the additional file can be written (S11). However, in the case of deletion, the judgment is not required. The information of a file to be deleted, the user management table and the file management table information are acquired (S50). As accommodated unused capacity is caused because of the deletion of the file, it is judged whether all files of a user in the group are stored at the upper limit redundant number. When all the files of all the users in the group are stored at the upper limit redundant number, processing proceeds to a step S52. If not, the processing proceeds to a step S53 (S51).

As the redundant number of the file is not required to be changed when all the files of all the users in the group are stored at a value of the upper limit redundant number, file deletion setting is made and the process is finished (S52, S57, S15, S16). When all the files of all the users in the group are not stored at the value of the upper limit redundant number, an accommodated unused area newly caused is redistributed (S53 to S56). As processing in the steps S53, S55 and S56 is similar to the processing in S27, S29, S30 in FIG. 6, the description is omitted. Total accommodated capacity and the physical used capacity of the deleted file are added and a result is set to capacity before distribution (S54). The processing proceeds to steps S56, S57, S15 and S16, the file is deleted, and its redundant number is adjusted.

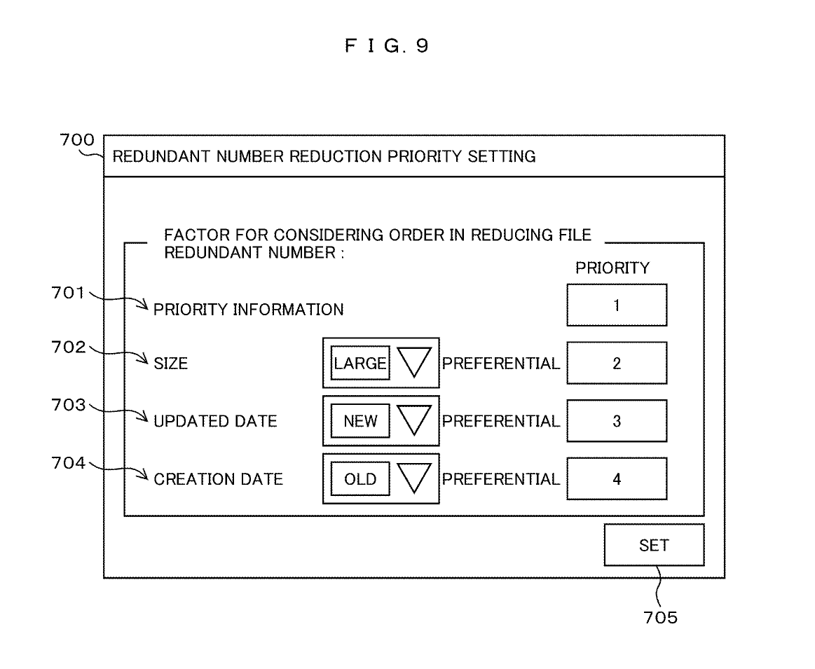

FIG. 9 shows an example of a redundant number reduction priority setting screen 700 of the management terminal 200 or the client 300. The redundant number reduction priority setting screen 700 enables setting order in which a redundant number of a file is reduced. Priority information 701, a file size 702, an updating date 703 and a creation date 704 are displayed, as to the file size 702, the updating date 703 and the creation date 704, criteria of “large” or “small” and “new” or “old” are selected, and a change of the priority of respective displayed items can be input. Further, the redundant number reduction priority setting screen is provided with a setting button 705 for setting the update of priority in the file management table 600.

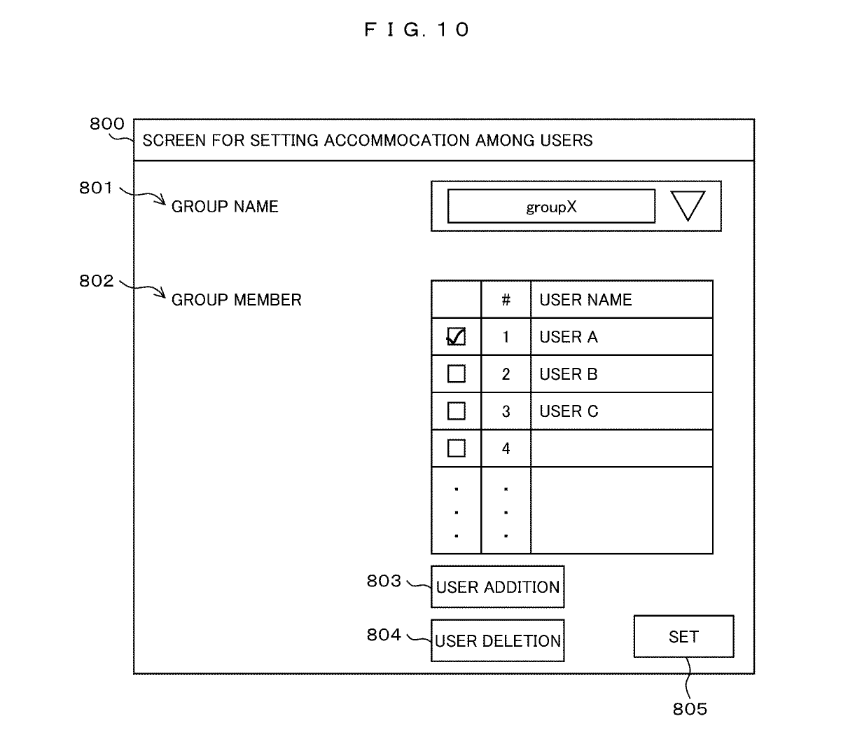

FIG. 10 shows an example of a screen for setting accommodation among users 800 of the management terminal 200 or the client 300. The screen for setting accommodation among users 800 displays a group name 801 showing a range of accommodation and group members 802 and a change can be set on the screen. Further, the screen is provided with a user addition button 803 for adding a user to the corresponding group, a user deletion button 804 for deleting a user from the corresponding group and a setting button 805 for setting in the user management table 500.

As described above, the redundancy of a file can be enhanced by accommodating unused capacity of each user in the belonging group and a user who uses excess capacity by borrowing can recover the capacity by reducing the redundancy of a file.

### Second Embodiment

Referring to FIGS. 3, 11 and 12, a second embodiment will be described below. In the second embodiment, accommodable (unused) capacity is accommodated not in units of group but every user. Operation when a user who lends another user own capacity writes a file will be described using not the items 513 to 516 related to the group but the lent/borrowed capacity 517 in the user management table 500 shown in FIG. 3 below. In a field of the lent/borrowed capacity 517, the total on a vertical line (in columns of the table) is capacity (total borrowed capacity) acquired by totaling borrowed capacity and the own values which the users themselves can utilize in the physical allocation capacity 503 and the total on a horizontal line (a row of the table) is accommodated capacity. In FIG. 3, a situation in which the user C lends the user A the capacity of 15 Gbytes is shown.

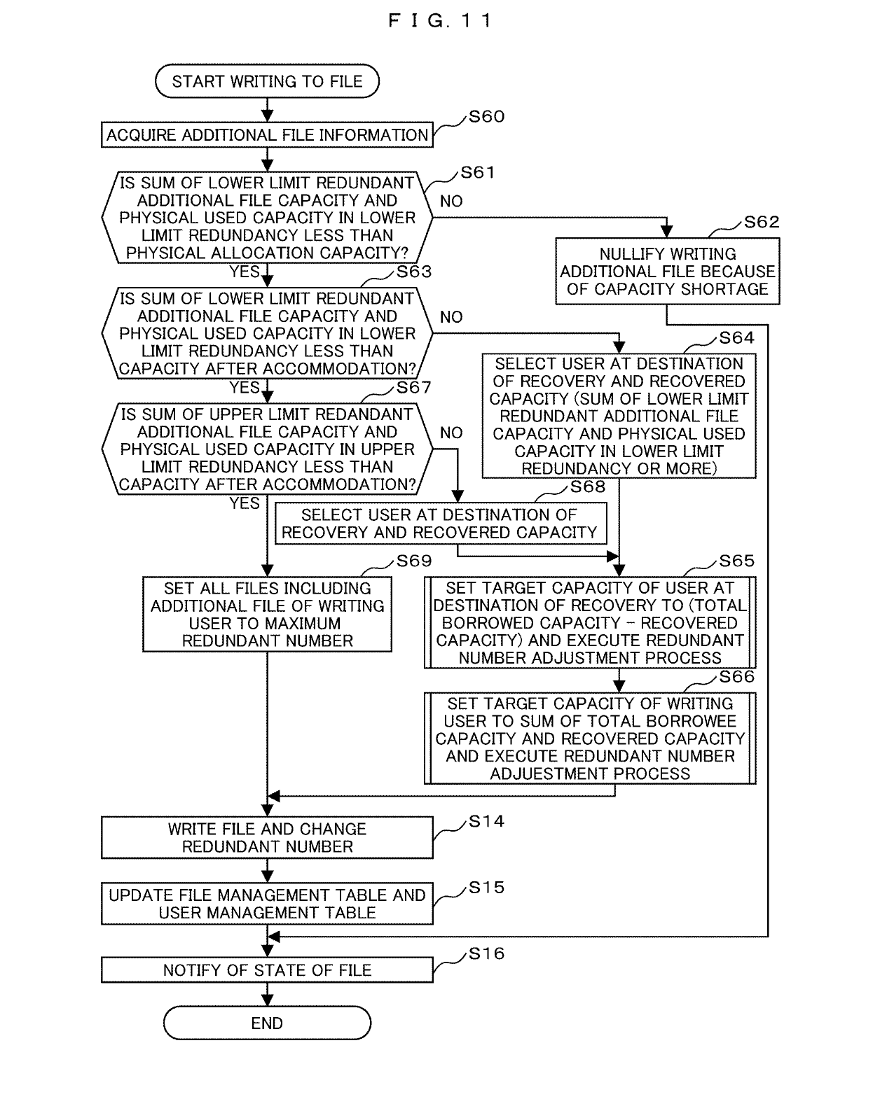

FIG. 11 is an example of a flowchart showing a process in file writing by the data manager 141 of the gateway 100. The description of the similar steps to those in S14 to S16 in FIG. 5 and FIG. 7 is omitted. Additional file information, the user management table and file management table information are acquired (S60). It is judged using the user management table 500 whether capacity acquired by totaling the capacity in lower limit redundancy of an additional file and a value of physical used capacity in lower limit redundancy 508 exceeds a value of own physical allocation capacity 503. If the capacity exceeds the value of the physical allocation capacity 503, processing proceeds to a step S62 and if the capacity does not exceed the value, the processing proceeds to a step S63 (S61).

Since files that a user possesses cannot be maintained by only capacity allocated to the user when the capacity exceeds the value of the physical allocation capacity 503, the additional file cannot be written because of the shortage of capacity (S62). When the abovementioned total capacity does not exceed the value of the physical allocation capacity 503, it is judged whether the capacity acquired by totaling the capacity in lower limit redundancy of the additional file and the value of the physical used capacity in lower limit redundancy 508 exceeds capacity acquired by subtracting capacity lent to another user from the value of the own physical allocation capacity 503 or the total (capacity after accommodation) of the value of the own physical allocation capacity 503 and capacity borrowed from another user. When the total capacity exceeds the capacity after accommodation, the processing proceeds to a step S64 and when the total capacity does not exceed the capacity after accommodation, the processing proceeds to a step S67 (S63).

When the total value of the capacity in lower limit redundancy of the additional file and the value of the physical used capacity in lower limit redundancy 508 does not exceed the value of the physical allocation capacity 503 and exceeds the capacity after accommodation, storage capacity is short because the user lends another user capacity. Therefore, to recover the capacity, recovered capacity is set for a lent user (a user at a destination of recovery). At this time, the recovered capacity is required to be set to be the total capacity of the capacity in lower limit redundancy of the additional file and the value of the physical used capacity in lower limit redundancy 503 or more (S64). Processing for recovering the set capacity from the user at the destination of recovery is executed. Since a redundant number adjustment process is described in relation to FIG. 7, the description is omitted (S65). After the recovery of the capacity, the redundant number adjustment process for the user requesting writing is executed (S66).

A case where the total capacity of the capacity in lower limit redundancy of the additional file and the value of the physical used capacity in lower limit redundancy 503 does not exceed the value of the physical allocation capacity 503 and does not also exceed the capacity after accommodation will be described below. It is judged whether total capacity of capacity in upper limit redundancy of the additional file and a value of physical used capacity in upper limit redundancy 507 exceeds the capacity after accommodation. When the total capacity exceeds the capacity after accommodation, the processing proceeds to a step S68 and when the total capacity does not exceed the capacity after accommodation, the processing proceeds to a step S69 (S67). In the case of procession to S68, recovered capacity can be freely set, unlike S64. It is determined depending upon difference in the size of recovered capacity whether a file redundant number of the user requesting wiring is all maximum (S68). In the case of procession to S69, since writable capacity exists even if a redundant number of the additional file is maximum, the redundant number of the additional file is set to a maximum redundant number (S69). In S69, the already existing all files may or may not be set to a maximum redundant number.

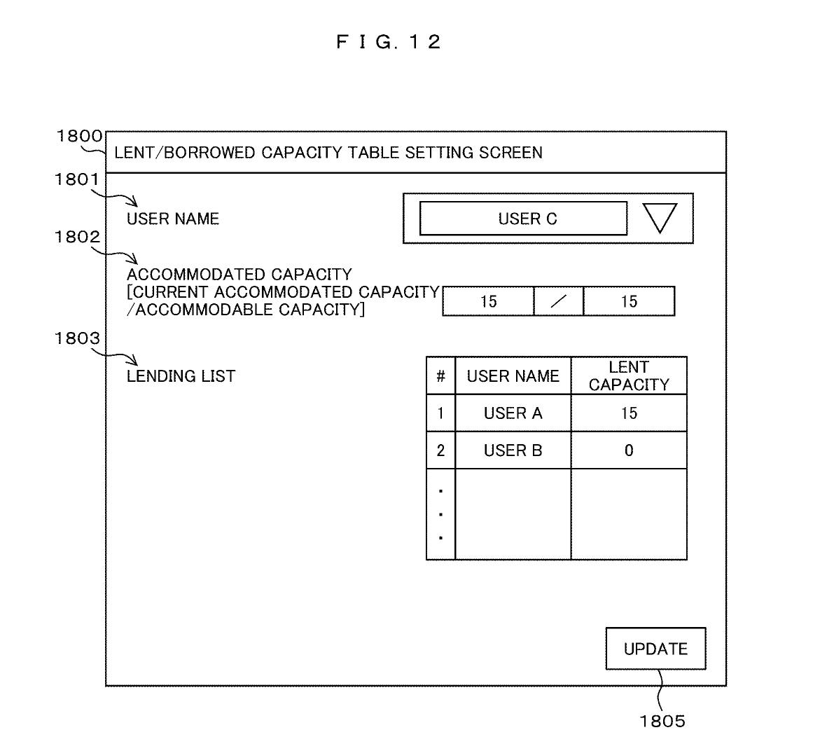

FIG. 12 shows an example of a lent/borrowed capacity table setting screen 1800 operated by the management terminal 200 or the client 300. On the lent/borrowed capacity table setting screen 1800, a user name 1801, accommodated capacity 1802 and a lending list 1803 are displayed and information in the lent/borrowed capacity 517 of the user management table 500 is updated by an updating button 1805. The user name 1801 is an item for selecting a user name to be updated. The accommodated capacity 1802 includes the current accommodated capacity and accommodable capacity and the current accommodated capacity does not exceed the accommodable capacity. The lending list 1803 is a list showing capacity and user names which a user having the user name 1801 is currently lending.

As described above, when capacity is short in writing the additional file, a user can write the additional file not by reducing a redundant number of each user in a belonging group and recovering capacity but by reducing a redundant number of a specific user at the destination of recovery and recovering capacity. Therefore, a range where recovery has an effect is small and recovery may be able to be processed at high speed.

### Third Embodiment

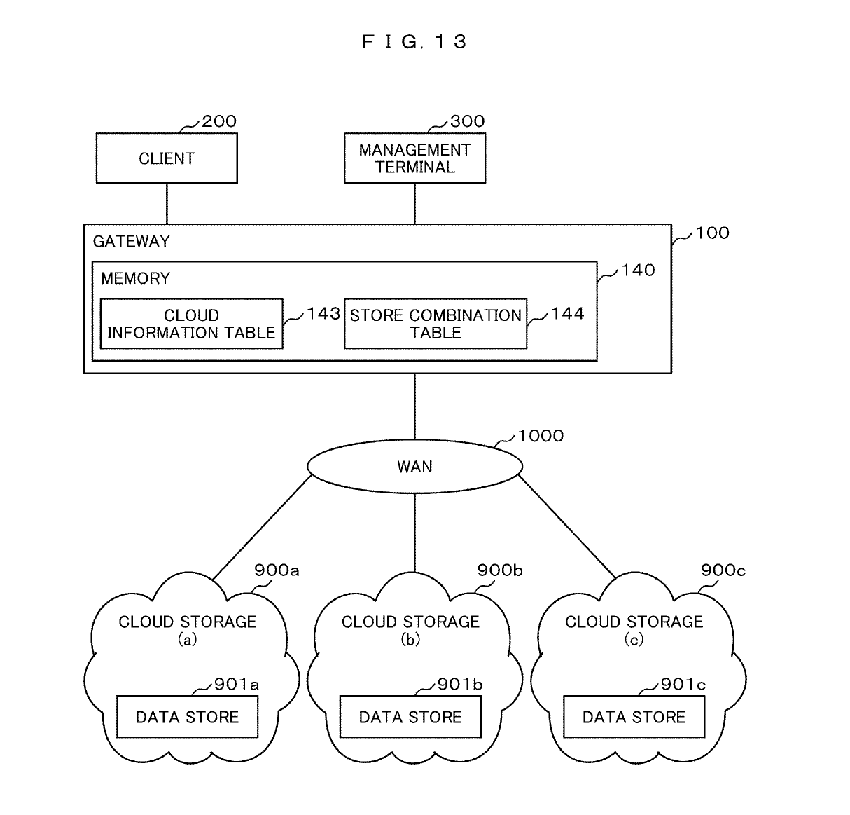

Referring to FIGS. 13 to 16, a third embodiment will be described below. In the third embodiment, operation in a case where a file is stored over an area allocated to a user (hereinafter called a logical allocation area) when a manager allocates capacity of a cloud storage to each user will be described. The file is protected by SLA, and (1) processing for storing the file by reducing a redundant number and securing an unused physical allocation area when the capacity of the file exceeds an initial logical allocation area and (2) processing for complementing a redundant number by borrowing an unused physical allocation area from another user when the redundant number is reduced are executed.

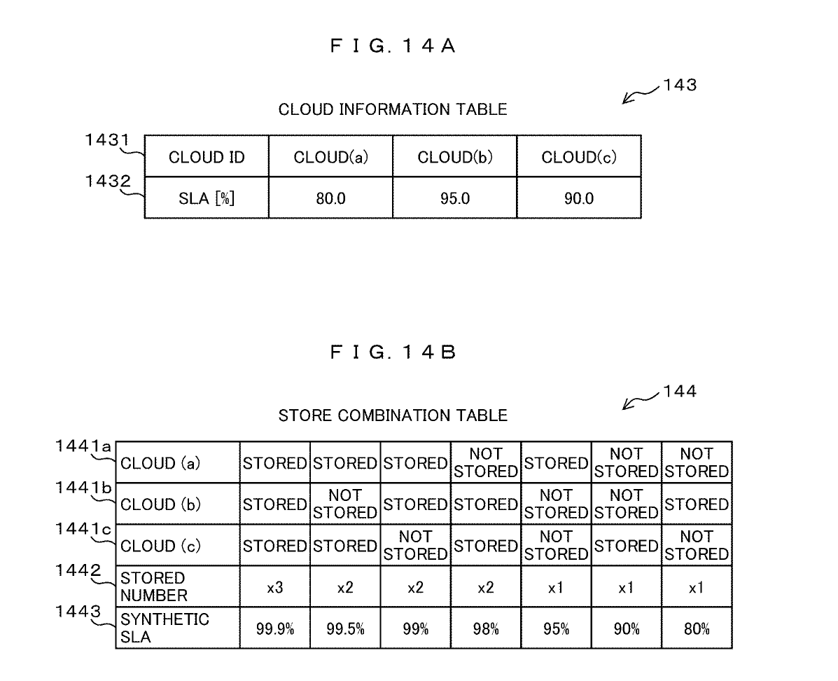

FIG. 13 shows an example of the configuration of a system using a cloud storage. In place of connecting the storage device 400 shown in FIG. 2, a cloud storage 900 is connected to a gateway 100 via WAN 1000. Besides, in a memory 140, a cloud information table 143 described referring FIG. 14A and a store combination table 144 described referring to FIG. 14B are stored. The cloud storage 900 possesses a data store 901, stores and manages files.

FIG. 14A shows an example of the cloud information table 143. The cloud information table 143 holds a cloud ID 1431 for identifying the cloud storage and a value of SLA 1432 of each cloud. FIG. 14B shows an example of the store combination table 144. A state of a store 1441 shows whether a file is stored in each cloud storage 900 or not. A stored number 1442 shows the number of cloud storages 900 in which a file is stored. Synthetic SLA 1443 shows a value when SLAs of the cloud storages 900 in which the file is stored are synthesized.

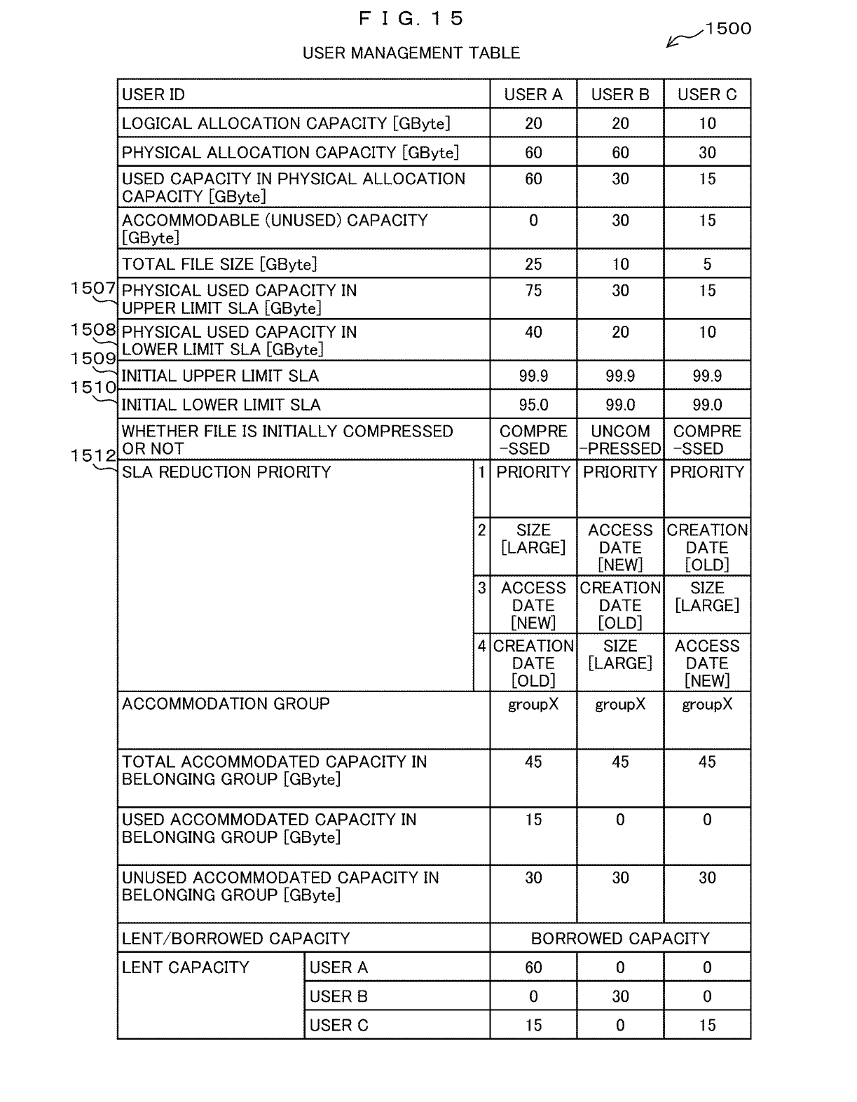

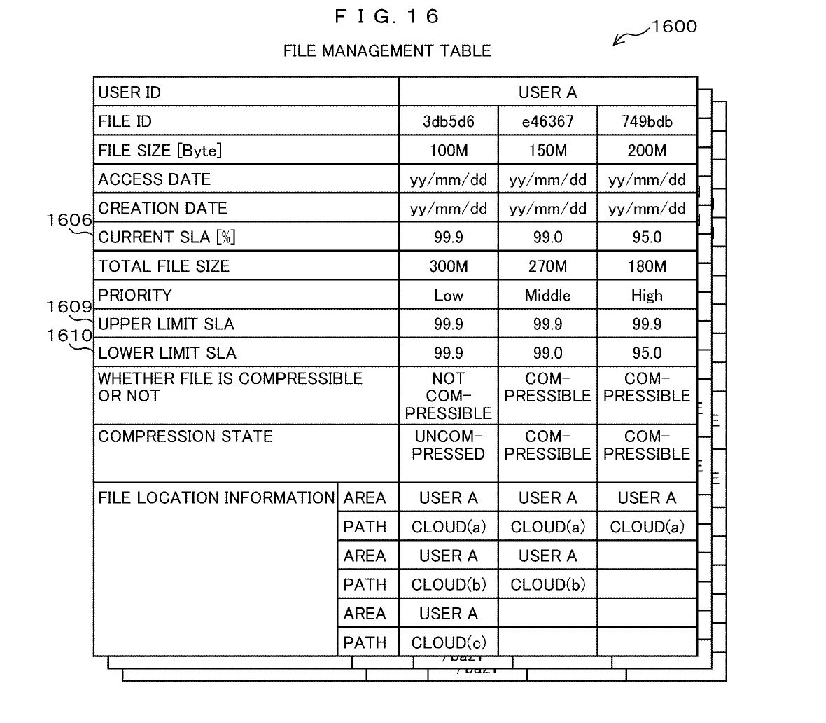

FIG. 15 shows an example of a user management table 1500 corresponding to a cloud. Only items different from the items in the user management table 500 shown in FIG. 3 and modified for the cloud will be described below and the description of the similar part to the part shown in FIG. 3 is omitted. Physical used capacity in upper limit SLA 1507 shows total capacity of physical used capacity when all files that the corresponding user possesses are at a level of upper limit SLA 1609 (see FIG. 16) set for each file. Physical used capacity in lower limit SLA 1508 shows total capacity of physical used capacity when all files that the corresponding user possesses are at a level of lower limit SLA 1610 (see FIG. 16) set for each file. Initial upper limit SLA 1509 shows initial upper limit SLA set for an added file. Initial lower limit SLA 1510 shows initial lower limit SLA set for the added file. SLA reduction priority 1512 is priority information for determining order in which SLA is reduced.

FIG. 16 shows an example of a file management table 1600 corresponding to the cloud. Only items different from the items in the file management table 600 shown in FIG. 4 and modified for the cloud will be described below and the description of the similar part to the part shown in FIG. 4 is omitted. Current SLA 1606 shows a current SLA value of each file. Upper limit SLA 1609 shows a value of maximum SLA which each file can set. Lower limit SLA 1610 shows a value of the lowest SLA which each file can set.

In a process using the user management table 1500 and the file management table 1600, the processing of the items in the process described in the first embodiment has only to be changed to the corresponding items for the cloud. Availability information of SLA may also be defined by calculating (MTBF/(MTBF+MTTR))*100 and others. In this case, MTBF means mean time between failure and MTTR means mean time to repair.

As described above, in the cloud system, unused capacity of each user in a belonging group is accommodated and the availability of a file can also be enhanced, a user who uses excess capacity by borrowing lowers the availability of the file, and the user can make the capacity recovered. The usage efficiency of storage resources that store big data of the cloud system is enhanced and the reliability can be secured.

### REFERENCE SIGNS LIST

100: Gateway, 141: Data manager, 142: Redundant number calculator, 143: Cloud information table, 144: Store combination table, 145: Capacity recoverer, 200: Management terminal, 300: Client, 400: Storage device, 500: User management table, 600: File management table, 900: Cloud storage

1. A file management method of storing a file from a client in a storage device in a state where the file is made redundant by a certain redundant number, comprising:
a first step of accepting an additional file from the client to the storage device;
a second step of comparing capacity of the additional file and unused physical capacity of the storage device; and
a third step of changing the redundant number of the already stored file, increasing the unused physical capacity and storing the additional file in the storage device when the capacity of the additional file is larger than the unused physical capacity.

2. The file management method according to claim 1, further comprising:
a step of allocating physical allocation capacity of the storage device to a plurality of respective users;
a step of setting an upper limit redundant number and a lower limit redundant number as a range of the redundant number;
a step of adding capacity when the additional file is made redundant by the lower limit redundant number and capacity when all the stored files of the first user who possesses the additional file are made redundant by the lower limit redundant number and comparing the added capacity with the first physical allocation capacity allocated to the first user; and
a step of disenabling writing the additional file when the added capacity is larger.

3. The file management method according to claim 2, comprising:
a second step and a third step which are based upon the second step and the third step and in which the capacity of the additional file is first capacity when the additional file is made redundant by the upper limit redundant number.

4. The file management method according to claim 3, comprising a third step based upon the third step of:
adding the first capacity and capacity when all the already stored files of the first user are made redundant by the upper limit redundant number in a case where the first capacity is larger than the unused physical capacity;
comparing the added capacity and the first physical allocation capacity;
reducing the redundant number of the already stored file and increasing the unused physical capacity; and
storing the additional file in the storage device.

5. The file management method according to claim 4, comprising:
a third step which is based upon the third step and in which it means that the unused physical capacity is increased by reducing the redundant number of the stored file one by one according to redundant number reduction priority affixed to the stored file to change the redundant number of the already stored file and increase the unused physical capacity.

6. The file management method according to claim 1, comprising:
a step of accepting a request from the client for deleting a file in the storage device; and
a step of increasing a redundant number of the stored file using the unused physical capacity increased by the deletion of the file.

7. The file management method according to claim 1,
wherein the storage device is a cloud storage; and
the redundant number is availability,
the method comprising a third step based upon the third step of:
changing the availability of the already stored file and increasing the unused physical capacity when the capacity of the additional file is larger than the unused physical capacity and storing the additional file in the cloud storage.

8. A file management method of allocating physical allocation capacity of a storage device to a plurality of respective users, enabling lending/borrowing the allocated physical allocation capacity and storing a file from a client of the user in the storage device in a state where the file is made redundant by a certain redundant number, comprising:
a step of accepting a request from the client for storing an additional file in the storage device;
a step of adding capacity of the additional file and capacity of all the already stored files of the first user who possesses the additional file and comparing the added capacity with capacity acquired by subtracting lent capacity from the physical allocation capacity allocated to the first user; and
a step of changing a redundant number of an already stored file of a user at the destination of lending and storing the additional file in capacity made free by changing the redundant number when the added capacity is larger.
